(19) United States
(12) Patent Application Publication
(10) Pub. No.: US 2009/0228331 A1
(43) Pub. Date: Sep. 10, 2009

(54) CONTENT DISTRIBUTION SERVER, COMPUTER READABLE RECORDING MEDIUM RECORDED WITH CONTENT DISTRIBUTION PROGRAM, AND CONTENT DISTRIBUTION METHOD

(75) Inventors: Yumiko NAKAMURA, Kawasaki (JP); Masahide Akase, Kawasaki (JP); Rie Shiragami, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/354,244

(22) Filed: Jan. 15, 2009

(30) Foreign Application Priority Data
Mar. 4, 2008 (JP) 2008-053937

(51) Int. Cl. G06Q 30/00; G06Q 10/00; G06F 15/16

(52) U.S. Cl. 705/10; 705/27; 705/14; 709/206

(57) ABSTRACT

A content distribution server for distributing content through a network has a content storage, an advertisement information storage storing advertisement images corresponding to location information showing a location of an advertisement target facility, a viewing request receiver receiving a request for viewing the content from a user device, a display target image judge acquiring the electronic document, showing the contents of the content designated by the viewing request, from the content storage and judging the picture data, designated as the display target by the acquired electronic document, a display target advertisement determiner acquiring the location information attached to the display target image, calculating a distance between locations where the display target image has been taken and each of a plurality of advertisement target facilities from the acquired location information and each location information of a plurality of advertisement images in the content storage, and determining an advertisement image.

### CROSS-REFERENCE TO RELATED APPLICATIONS

This application is based upon and claims the benefit of priority of the prior Japanese Patent Application No. 2008-53937, filed on Mar. 4, 2008, the entire contents of which are incorporated by reference herein.

### BACKGROUND

1. Field

The present invention relates to a content distribution server for distributing content through a network, a computer readable recording medium recorded with a content distribution program, and a content distribution method, and more particularly to a content distribution server for distributing content including a picture, a computer readable recording medium recorded with a content distribution program, and a content distribution method.

2. Description of the Related Art

Various services have been provided recently using the internet with the development of information and communications technology and the increasing of the number of users of the internet. The services using the internet include providing a part of a storage area in a web server as a data storage site for a personal website for general users. In such a service for general users, in some cases, the service is provided for users going online for free or for minimal cost. The actual income is obtained from the advertising fee provided to the website. In other case, money may be paid to a developer of a website according to access to the site of an advertiser through an advertisement displayed on the website.

When the income is obtained from the advertising fee, it is necessary to devise the advertisement so that the website audience is interested in the advertisement. For example, there is a method of displaying advertisements of a product and a service, associated with a place where a moving image is taken, on a mobile communication terminal to which the taken moving image is distributed. In this method, a place where a camera is installed is fixed, and the location of the camera (for example, in a kindergarten) is previously known. Therefore, a distribution destination (for example, the parents of the kindergarten children) of a video taken by the camera can be specified, whereby appropriate advertisements (children's clothing and toys) can be predetermined.

However, in the above method, an appropriate advertisement cannot be provided to an image or a video taken at a large indefinite number of places. Namely, when an advertisement is provided at a website distributing images such as photographs provided from various users, a provider of a service cannot know where the image was taken before the uploading of the image. Therefore, it is impossible to predict the tendency of the audience who will be interested in the image, and the appropriate advertisement corresponding to the distribution destination of the image cannot be selected.

The invention has been made in view of the above problem, and it is an object of the invention to provide a content distribution server, which can realize the distribution of a picture taken at an arbitrary place and an appropriate advertisement corresponding to the place where the picture was taken, a computer readable recording medium recorded with a content distribution program, and a content distribution method.

### SUMMARY

In order to solve the above problem, the invention provides a content distribution server for distributing content through a network having the following functions.

A content storage stores an electronic document showing the contents of the content and including a description for designating picture data to be displayed in the content and the picture data attached with location information showing a picture-taking location. An advertisement information storage stores a plurality of advertisement images corresponding to location information showing a location of an advertisement target facility. A viewing request receiver receives a request for viewing the content from a user device connected through the network. A display target image judge acquires the electronic document, showing the contents of the content designated by the viewing request, from the content storage and judges the picture data, designated as a display target by the acquired electronic document, as a display target image. A display target advertisement determiner acquires the location information attached to the display target image, calculates a distance between a location where the display target image has been taken and each of a plurality of advertisement target facilities from the acquired location information and each location information of a plurality of advertisement images in the content storage, and preferentially determines an advertisement image of the advertisement target facility, located at a close distance from the location where the display target image has been taken, as the display target. An advertisement attacher adds an advertisement display description, for displaying the advertisement image determined as the display target by the display target advertisement determiner, to the electronic document showing the contents of the content designated by the viewing request. An electronic document sender sends the electronic document, to which the advertisement display description is added by the advertisement attacher, to the user device.

The above-described embodiments of the present invention are intended as examples, and all embodiments of the present invention are not limited to including the features described above.

### BRIEF DESCRIPTION OF THE DRAWINGS

FIG. 1 is a view showing an outline of an embodiment;

FIG. 2 is a view showing a system configuration example of the present embodiment;

FIG. 3 is a view showing a configuration example of hardware of a web server used in the present embodiment;

FIG. 4 is a block diagram showing a function of the web server of a portal site;

FIG. 5 is a view showing a data configuration example in a personal site information storage part;

FIG. 6 is a view showing a data configuration example in picture data;

FIG. 7 is a view showing a data configuration example in an advertisement information storage part;

FIG. 8 is a view showing a data configuration example in an advertisement management table;

FIG. 9 is a flow chart showing a procedure of a web page distribution processing;

FIG. 10 is a flow chart showing a procedure of a comment response advertisement selection processing based on single location information;

FIG. 11 is a flow chart showing a procedure of the comment response advertisement selection processing based on a plurality of location information;

FIG. 12 is a flow chart showing a procedure of a category response advertisement selection processing based on single location information;

FIG. 13 is a flow chart showing a procedure of the category response advertisement selection processing based on a plurality of location information;

FIG. 14 is a flow chart showing a procedure of an advertisement selection processing based on single location information;

FIG. 15 is a flow chart showing a procedure of the advertisement selection processing based on a plurality of location information;

FIG. 16 is a view showing city's facilities;

FIG. 17 is a view showing an example of advertisement display corresponding to a picture taken at one facility other than advertisers;

FIG. 18 is a view showing an example of advertisement display corresponding to a photograph taken at a plurality of facilities other than the advertisers;

FIG. 19 is a view showing an example of advertisement display corresponding to a picture taken at one facility of the advertiser;

FIG. 20 is a view showing an example of advertisement display corresponding to a picture taken at a plurality of facilities of the advertiser;

FIG. 21 is a view showing an example of advertisement display corresponding to a comment of a picture taken at one facility; and

FIG. 22 is a view showing an example of advertisement display corresponding to the comment of the picture taken at a plurality of facilities.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

Hereinafter, the embodiment of the invention will be described with reference to drawings.

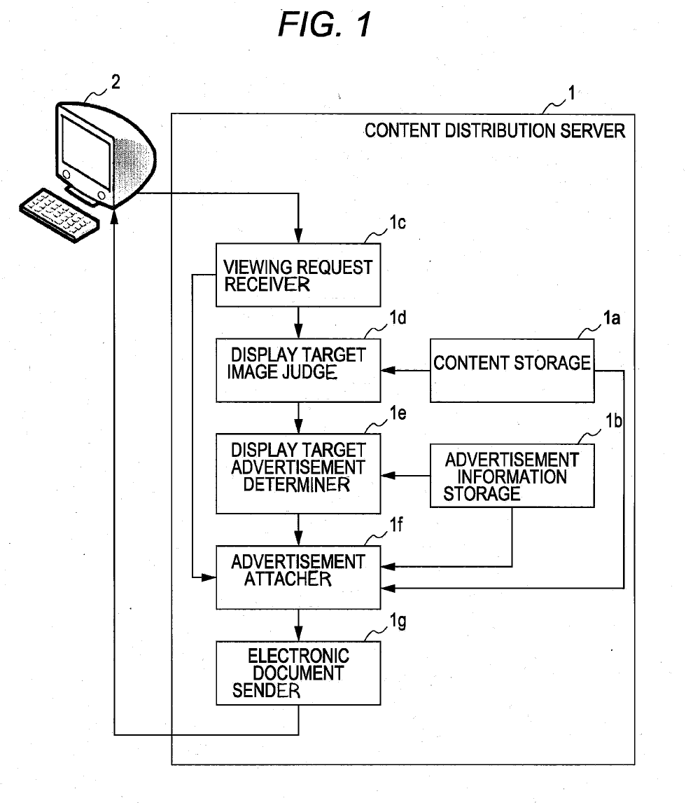

FIG. 1 is a view showing an outline of the embodiment. A content distribution server 1 for distributing content through a network has a content storage 1a, advertisement information storage 1b, a viewing request receiver 1c, a display target image judge 1d, a display target advertisement determiner 1e, an advertisement attacher 1f, and an electronic document sender 1g.

The content storage 1a stores therein an electronic document showing contents of content and including a description for designating picture data displayed in the content. The electronic document is, for example, a document for a web page described in HTML (HyperText Markup Language). If HTML is used, the picture data to be displayed in content can be designated by using a tag for inline display. Further, the content storage unit 1a stores therein picture data attached with location information showing a location where the picture has been taken.

The advertisement information storage 1b stores therein a plurality of advertisement images corresponding to the location information showing a location of an advertisement target facility.

The viewing request receiver 1c receives a request for viewing the content from a user device 2 connected to the viewing request receiver 1c through the network.

The display target image judge 1d acquires the electronic document, showing the contents of the content designated by the viewing request, from the content storage 1a. Further, the display target image judge 1d judges the picture data, designated as a display target in the acquired electronic document, as a display target image.

The display target advertisement determiner 1e acquires the location information attached to the display target image. Next, the display target advertisement determiner 1e calculates a distance between a location where the display target image has been taken and each of a plurality of advertisement target facilities from the acquired location information and each location information of the plurality of advertisement images in the content storage 1a. The display target advertisement determiner 1e then preferentially determines the advertisement image of the advertisement target facility, located at a close distance from the location where the display target image has been taken, as the display target.

The advertisement attacher 1f adds an advertisement display description for displaying the advertisement image, determined as the display target by the display target advertisement determiner 1e, to the electronic document showing the contents of the content designated by the viewing request. For example, the advertisement attacher 1f provides a frame for displaying the advertisement image in the electronic document and adds a technique for inline displaying the advertisement image in the frame.

The electronic document sender 1g sends the electronic document, to which the advertisement display description is added by the advertisement attacher 1f, to the user device 2.

When the request for viewing the content is sent from the user device 2 to the content distribution server 1, the viewing request is received by the viewing request receiver 1c. Next, the display target image judge 1d acquires the electronic document, showing the contents of the content designated by the viewing request, from the content storage 1a. Further, display target image judge 1d judges the picture data, designated as the display target in the acquired electronic document, as the display target image.

When the display target image is judged, the location information attached to the display target image is acquired by the display target advertisement determiner 1e. Next, the display target advertisement determiner 1e calculates the respective distance between the location where the display target image has been taken and each of the plurality of advertisement target facilities from the acquired location information and location information of the plurality of advertisement images in the content storage 1a. The display target advertisement determiner 1e then preferentially determines the advertisement image of the advertisement target facility, located at a close distance from the location where the display target image has been taken, as the display target.

When the advertisement image to be displayed is determined, the advertisement attacher 1f adds the advertisement display description for displaying the advertisement image, determined as the display target by the display target advertisement determiner 1e, to the electronic document showing the contents of the content designated by the viewing request. The electronic document sender 1g sends the electronic document, to which the advertisement display description is added by the advertisement attacher 1f, to the user device 2.

As described above, the advertisement of the advertisement target facility located close to a location where the picture data displayed in the electronic document has been taken can be preferentially added to the electronic document. As a result, the advertisement image of the advertisement target facility located close to the location where the picture data as the display target image has been taken is preferentially displayed in the content. According to this embodiment, the advertisement suitable for a region where a picture has been taken can be displayed.

The distribution of the electronic document attached with the advertisement image is frequently used in the web page distribution through internet. Thus, the embodiment is hereinafter specifically described by exemplifying the case where an appropriate advertisement image based on the location information is distributed by using WWW (World Wide Web) technique.

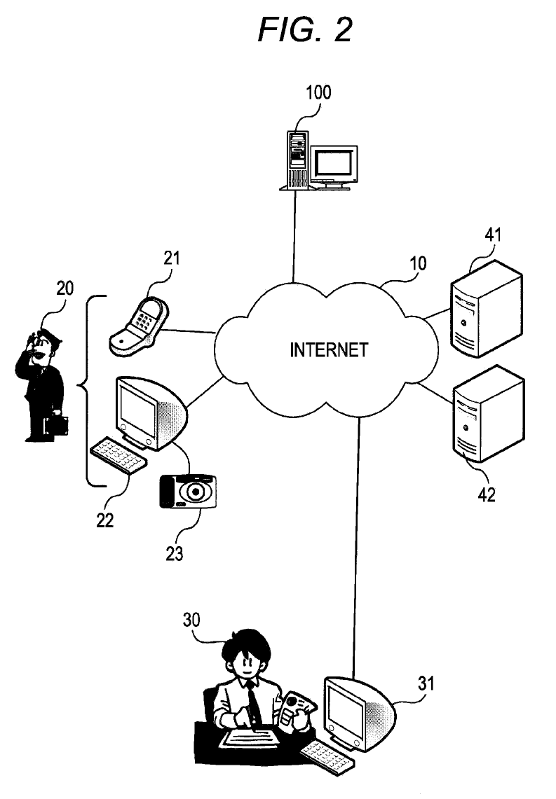

FIG. 2 is a view showing a system configuration example of this embodiment. An internet 10 is connected with web servers 100, 41, and 42, a portable phone 21, and user devices 22 and 31.

The web server 100 provides a portal site. A personal web page created by an informant 20 is provided in the web server 100. The web server 100 further provides a service in which an advertisement of, for example, a company is automatically attached to the personal web page. Incidentally, an advertiser requests an administrator of the web server 100 to place an advertisement and pays the advertising fee, whereby the advertisement is registered.

The web servers 41 and 42 provide a website administrated by the advertiser who provides the advertisement through the web server 100 of the portal site.

The informant 20 uploads information with a picture on the web server 100 by using the portable phone 21 and the user device 22. The portable phone 21 realizes the communication through the internet 10, can acquire the location information through GPS (Global Positioning System) receiver, and has a camera. The informant 20 takes a picture at an arbitrary location by using the portable phone 21. When a picture is taken, the portable phone 21 acquires the location information at that time through the GPS to give the location information to the picture data. As the data format of the picture data to which various information can be attached, there is an Exif (Exchangeable Image File Format), for example. The informant 20 operates the portable phone 21 and uploads the picture data attached with the location information on the web server 100.

Further, the camera 23 can be connected to the user device 22. The informant 20 takes a picture by using the camera 23. The informant 20 transfers the picture data stored in the camera 23 to the user device 22. Further, the informant 20 operates the user device 22 and gives the location information, showing a location taken by the camera 23, to the picture data. For example, if the informant 20 can know the address of a location where a picture is taken, the informant 20 can know the latitude and the longitude by running the address with a map. The informant 20 operates the user device 22 to give the latitude and the longitude of the picture-taking location as the location information to the picture data, and thus to upload the picture data with the location information on the web server 100.

An information viewer 30 operates a user device 31 and accesses to the website of the informant 20 provided in the web server 100.

The location information showing the picture-taking location is attached to the picture data showing a picture image displayed in a personal web page in the web server 100. The web server 100 transmits an advertisement image associated with a shop near the location where the picture displayed in the web page has been taken simultaneously with the transmission of the web page. According to this embodiment, the information viewer 30 can view the picture data uploaded by the informant 20. At this time, an advertisement of an advertiser opening a location near the location where the picture data in the page has been taken is displayed in a page displayed in the user device 31. The information viewer 30 operates the user device 31 and selects the displayed advertisement, whereby the information viewer 30 can access to the advertiser's site corresponding to the selected advertisement.

When the access from the user device 31 to the web servers 41 and 42 of the advertiser is performed, the web page provided by the advertiser is displayed in the user device 31, whereby the advertiser pays money or gives points changeable with products to the creator of the personal web page on which the advertisement is placed. Therefore, it is considered that in order to receive more profits, the informant 20 posts many pictures or takes measures to post many pictures taken at the shop of the advertiser.

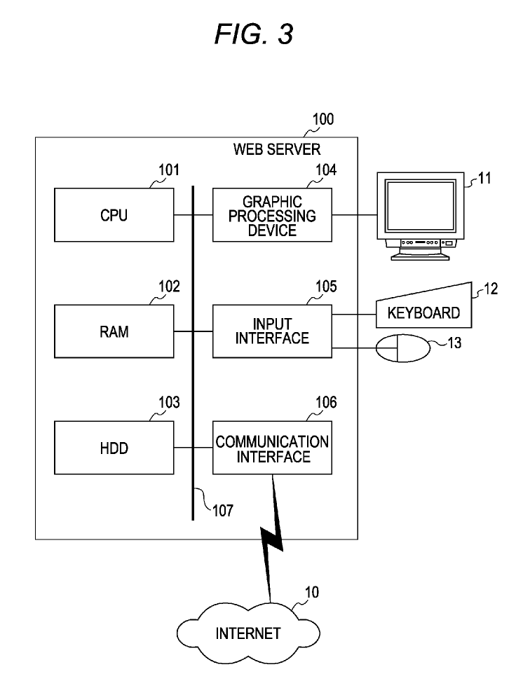

FIG. 3 is a view showing a configuration example of hardware of a web server used in the present embodiment. The entire web server 100 is controlled by a CPU (Central Processing Unit) 101. The CPU 101 is connected with a RAM (Random Access Memory) 102, a hard disk drive (HDD) 103, a graphic processing device 104, an input interface 105, and a communication interface 106 through a bus 107.

At least a part of an OS (Operating System) program and an application program executed by the CPU 101 is temporarily stored in the RAM 102. Further, various data required for processing performed by the CPU 101 is stored in the RAM 102. The OS and the application program are stored in the HDD 103.

The graphic processing device 104 is connected with a monitor 11 and displays an image on a screen of the monitor 11 in accordance with an instruction from the CPU 101. The input interface 105 is connected with a keyboard 12 and a mouse 13 and transmits a signal sent from the keyboard 12 and the mouse 13 to the CPU 101 through the bus 107.

The communication interface 106 is connected to the internet 10 and transmits and receives data with other computers through the internet 10.

According to the above hardware configuration, the processing function of the present embodiment can be realized. In FIG. 3, the hardware configuration of the web server 100 is illustrated; however, the web servers 41 and 42 and the user devices 22 and 31 can be realized by a similar hardware configuration.

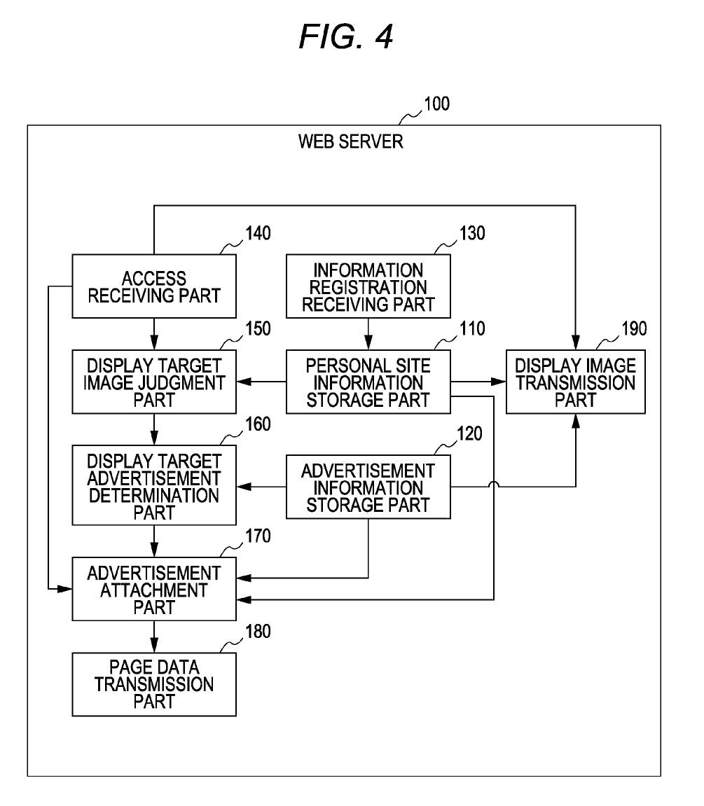

FIG. 4 is a block diagram showing a function of the web server of a portal site. The web server 100 has a personal site information storage part 110, an advertisement information storage part 120, an information registration receiving part 130, an access receiving part 140, a display target image judgment part 150, a display target advertisement determination part 160, an advertisement attachment part 170, a page data transmission part 180, and a display image transmission part 190.

The personal site information storage part 110 is a storage function of storing information (page data) of the web page uploaded by the informant 20. For example, a part of the storage area of the HDD 103 is used as the personal site information storage part 110.

The advertisement information storage part 120 is a storage function of storing advertisement management information for managing, for example, advertisement data such as a banner advertisement and a category to which a product or a service shown in each advertisement belongs. For example, a part of the storage area of the HDD 103 is used as the advertisement information storage part 120.

The information registration receiving part 130 receives a request for registering page data published on the website from the portable phone 21 or the user device 22 used by the informant 20. For example, the information registration receiving part 130 receives a request for registering an HTML document on a web page and image data including the location information. The information registration receiving part 130 having received the request for registering the page data performs user authentication for the informant 20 to thereby confirm that the informant 20 is a user permitted to use the personal site information storage part 110. In the user authentication, for example, a user ID or a password transmitted from the portable phone 21 or the user device 22 is matched to user's authentication information (a pair of the user ID and the password) previously registered in the information registration receiving part 130. When the user authentication for the informant 20 is correctly finished, the information registration receiving part 130 then stores the page data, sent with the registration request, in the personal site information storage part 110.

The access receiving part 140 receives a request for viewing the personal site information from the user device 31 used by the information viewer 30. Namely, an individual URL is given to each page data registered in the personal site information storage part 110. The access receiving part 140 receives the viewing request, in which the URL given to the information in the personal site information storage part 110 is designated, from the user device 31.

The access receiving part 140 discriminates whether the received viewing request is a request for acquiring page data (for example, a request for acquiring a file with an extension such as html) or a request for acquiring a display image (for example, a request for acquiring a file with an extension such as gif or jpg). Namely, when a web page is viewed in the user device 31 used by the information viewer 30, the request for acquiring the page data is first transmitted to the web server 100. When the structure of the page data acquired by the user device 31 is analyzed to detect the URL of an image which should be inline displayed, the request for acquiring the display image is transmitted to the web server 100.

Thus, when a web page is displayed in the user device 31, the acquisition of the page data and the acquisition of the display image are individually requested to the web server 100. Therefore, the access receiving part 140 discriminates whether the received viewing request is the request for acquiring the page data or the request for acquiring the display image. When the received viewing request is the request for acquiring the page data, the access receiving part 140 gives the viewing request to the display target image judgment part 150 and the advertisement attachment part 170 in order to add the description for inline displaying the advertisement on the page data. When the received viewing request is the request for acquiring the display image, the access receiving part 140 gives the viewing request to the display image transmission part 190.

The display target image judgment part 150 having received the viewing request from the access receiving part 140 acquires the page data (for example, an HTML document), shown in the viewing request, from the personal site information storage part 110. Next, the display target image judgment part 150 analyzes the acquired page data and judges the image data displayed in the page data. For example, when the acquired page data is the HTML document, the display target image judgment part 150 retrieves a tag showing the inline display of an image and specifies the image data, which should be displayed, on the basis of the URL of the image data represented by the tag. The display target image judgment part 150 then acquires the image data, to be displayed in the page data shown in the viewing request, from the personal site information storage part 100 and gives the image data to the display target advertisement determination part 160. At this time, the display target image judgment part 150 extracts a comment (for example, a character string before and after the tag showing the inline display), attached to the image data to be displayed, from the page data shown in the viewing request and gives the extracted comment and the image data to the display target advertisement determination part 160.

The display target advertisement determination part 160 determines the display target advertisement on the basis of the location information attached to the image data by the display target image judgment part 150. At this time, the display target advertisements are narrowed down based on a comment attached to the image data. Namely, the display target advertisement determination part 160 refers to the advertisement information storage part 120 and determines as the display target advertisement the advertisement attached with the location information in the vicinity of a location represented by the location information attached to the image data to be displayed. In addition, when there is the advertisement attached with the location information showing the same location as the location information attached to the image data to be displayed, the display target advertisement determination part 160 determines as a target to be displayed the advertisement in the same category as the advertisement attached with the location information showing the same location as the location information attached to the image data to be displayed. Further, when a comment is attached to the image data to be displayed, the display target advertisement determination part 160 narrows down the image data of the advertisement by the character string of the comment. When the advertisement which should be displayed is determined, the display target advertisement determination part 160 notifies the information of the advertisement (an identification number of the advertisement) to the advertisement attachment part 170.

The advertisement attachment part 170 acquires the page data, which has been received from the access receiving part 140 and is shown in the viewing request, from the personal site information storage part 110. The advertisement attachment part 170 further acquires the advertisement data of the display target advertisement, notified by the display target advertisement determination part 160, from the advertisement information storage part 120. The advertisement attachment part 170 then adds a description for inline displaying the display target advertisement to the acquired page data. Subsequently, the advertisement attachment part 170 gives the page data to which the description for advertisement display is added to the page data transmission part 180.

The page data transmission part 180 transmits the page data received from the advertisement attachment part 170 to the user device 31 which is a transmission source of the viewing request, whereby a page added with an advertisement is displayed in the user device 31 in which the page data is viewed.

The display image transmission part 190 having received the viewing request, which is the request for acquiring the display image, from the access receiving part 140 acquires the appropriate image from the personal site information storage part 110 or the advertisement information storage part 120. The display image transmission part 190 then transmits the acquired display image to the user device 31.

Next, the information stored in the personal site information storage part 110 and the information stored in the advertisement information storage part 120 are described in detail.

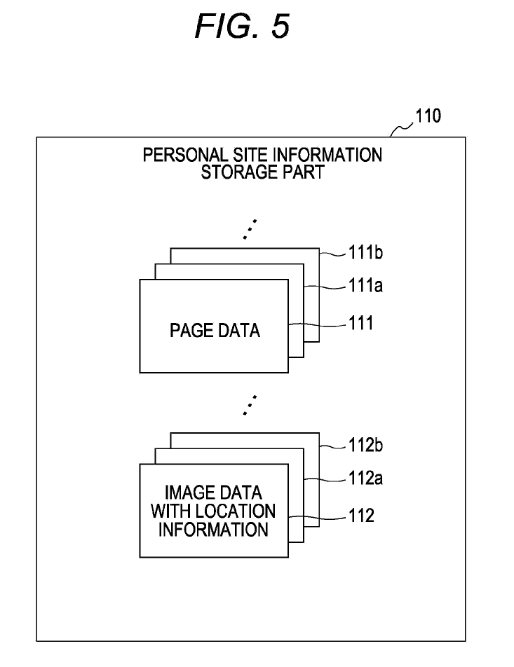

FIG. 5 is a view showing a data configuration example in the personal site information storage part 110. A plurality of page data 111, 111a, 111b, and . . . and a plurality of picture data 112, 112a, 112b, and . . . are stored in the personal site information storage part 110.

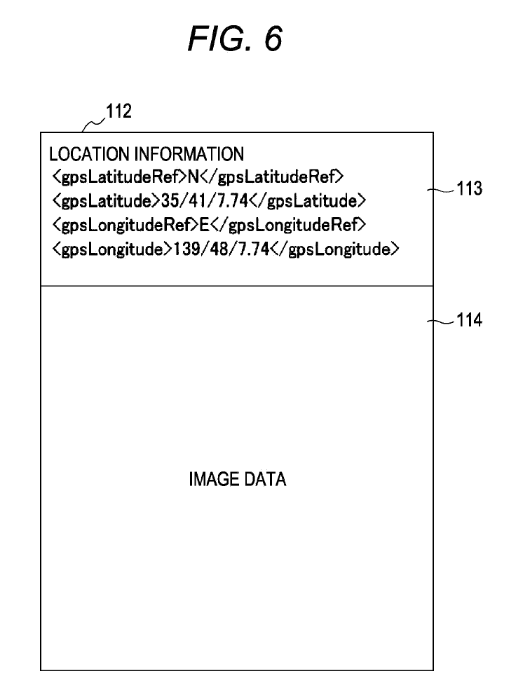

FIG. 6 is a view showing a data configuration example in the picture data. The picture data 112 has a location information part 113 and an image data part 114. The location information showing a location where an image shown in the image data part 114 has been taken is set in the location information part 113. In the example of FIG. 6, a “north latitude” is represented by <gpsLatitudeRef>N</gpsLatitudeRef>. A “latitude” is represented by <gpsLatitude>35/41/7.74</gpsLatitude>. An “east longitude” is represented by <gpsLongitudeRef>E</gpsLongitudeRef>. A “longitude” is represented by <gpsLongitude>139/48/7.74</gpsLongitude>.

Meanwhile, an image of a data format using a general-purpose compression technique such as GIF (Graphics Interchange Format) or JPEG (Joint Photographic Coding Experts Group) is set in the image data part 114. As the picture data 112, data of, for example, an Exif format can be used.

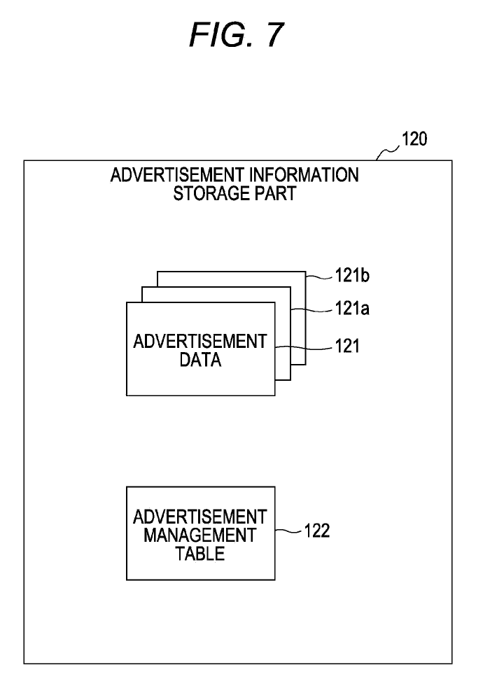

FIG. 7 is a view showing a data configuration example in the advertisement information storage part 120. A plurality of advertisement data 121, 121a, 121b, and . . . and an advertisement management table 122 are provided in the advertisement information storage part 120. The advertisement data 121, 121a, 121b, and . . . are banner advertisements and include advertisement images of products and services and link information to the website of an advertiser.

The advertisement management table 122 is a data table in which management information such as the location information associated with each of the advertisement data 121, 121a, 121b, and . . . is stored.

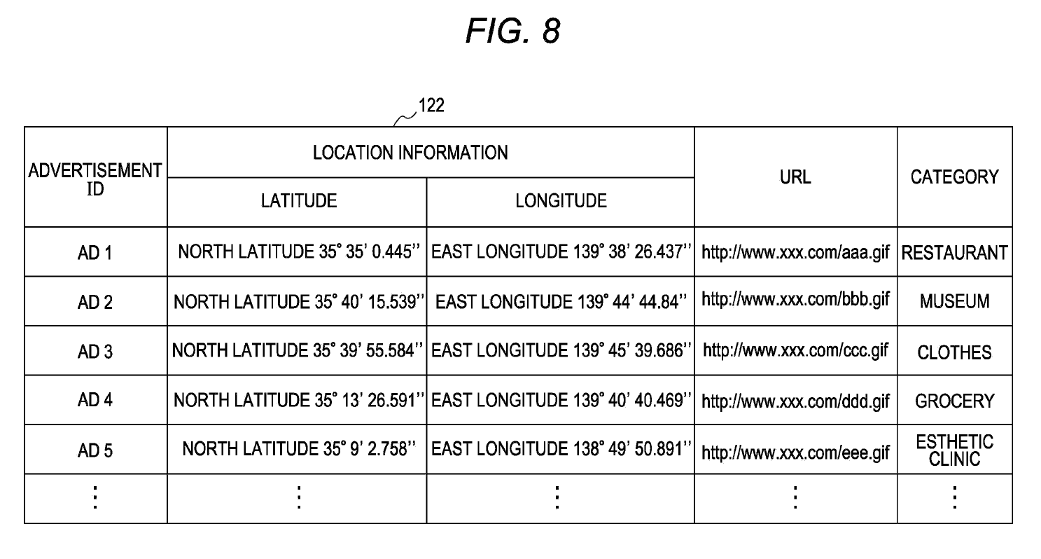

FIG. 8 is a view showing a data configuration example in the advertisement management table 122. The advertisement management table 122 includes columns for an advertisement ID, the location information, URL, and a category.

Identification information for uniquely identifying advertisement data is set in the column for the advertisement ID. The location information of a location associated with the advertisement shown in the advertisement data is set in the column of the location information. In the advertisement of a restaurant for example, the location associated with the advertisement is the location of a shop. The column of the location information is separated into a column of latitude and a column of longitude. The latitude of the location associated with the advertisement is set in the column of latitude. The longitude of the location associated with the advertisement is set in the column of longitude. The URL of the advertisement data is set in the column of URL. A category of the advertisement is set in the column of category. The category includes, for example, a restaurant and a museum.

The advertisement suitable for the appropriate image is distributed by the web server 100, constituted as above, on the basis of the location information of the image. Hereinafter, a procedure of a distribution processing of a web page with an advertisement is described in detail.

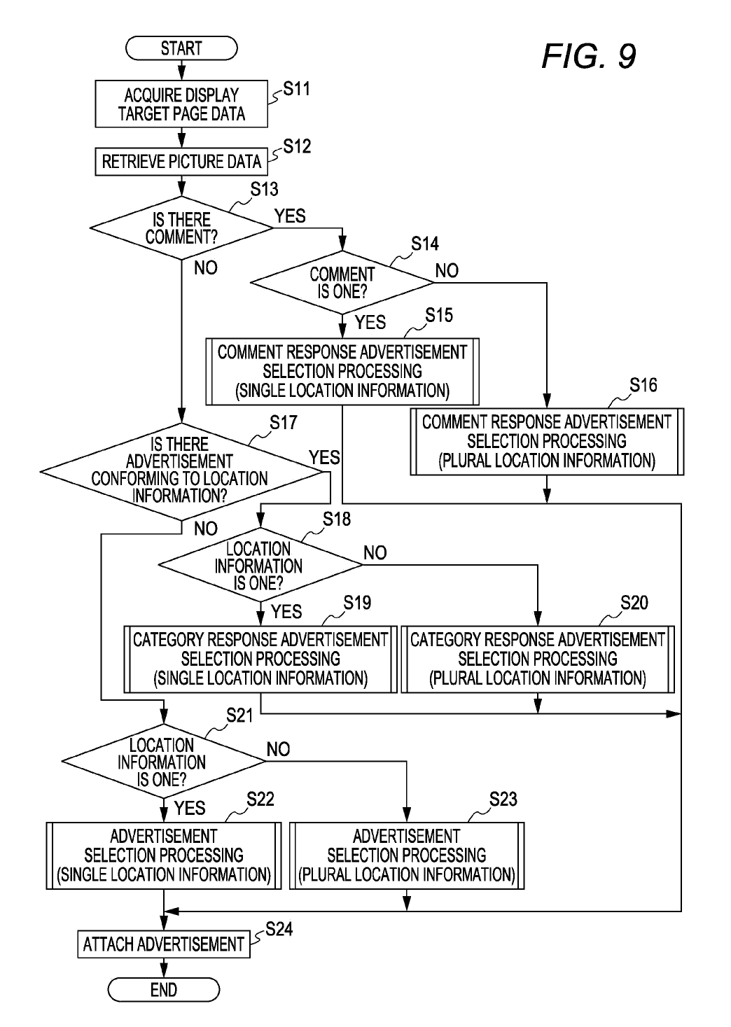

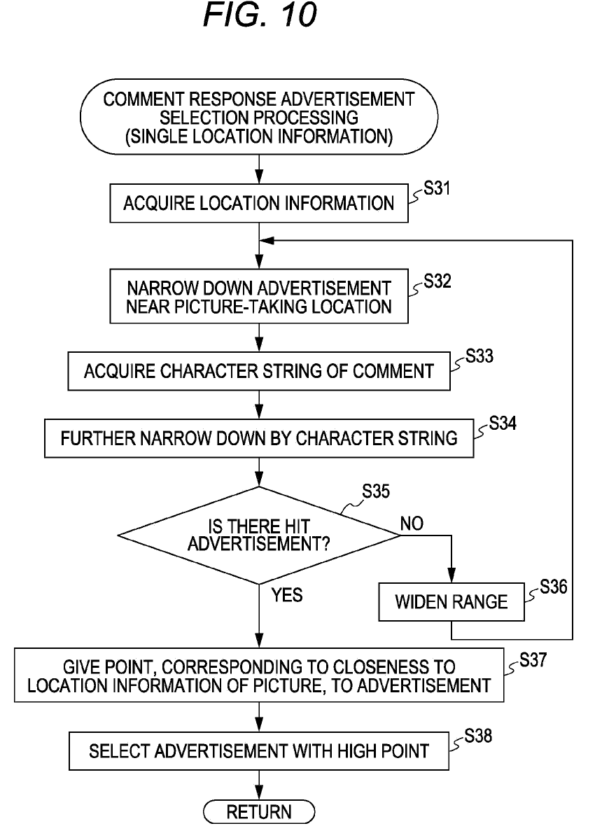

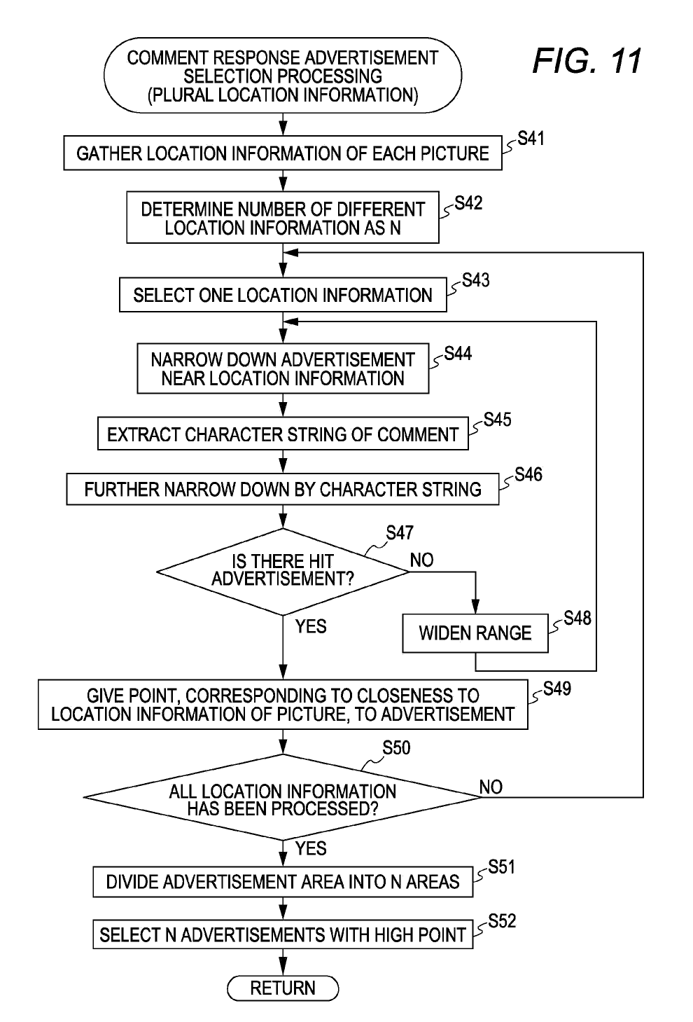

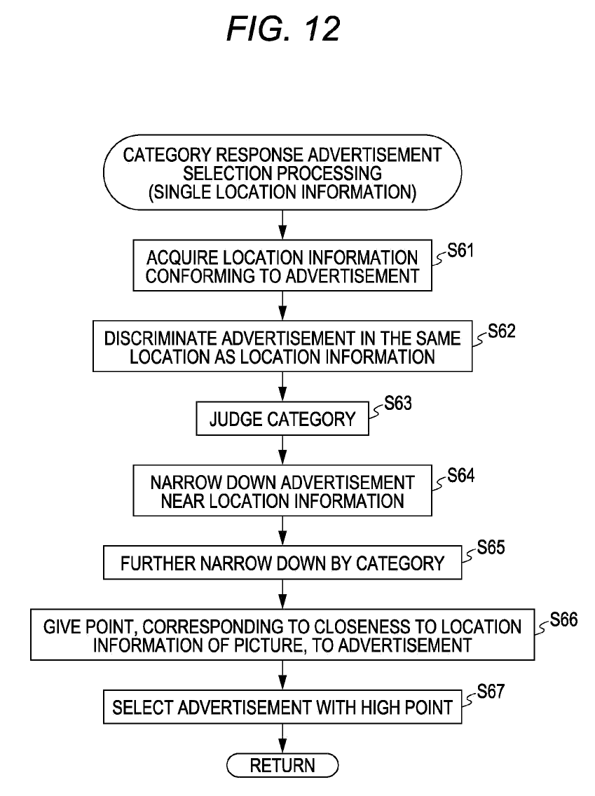

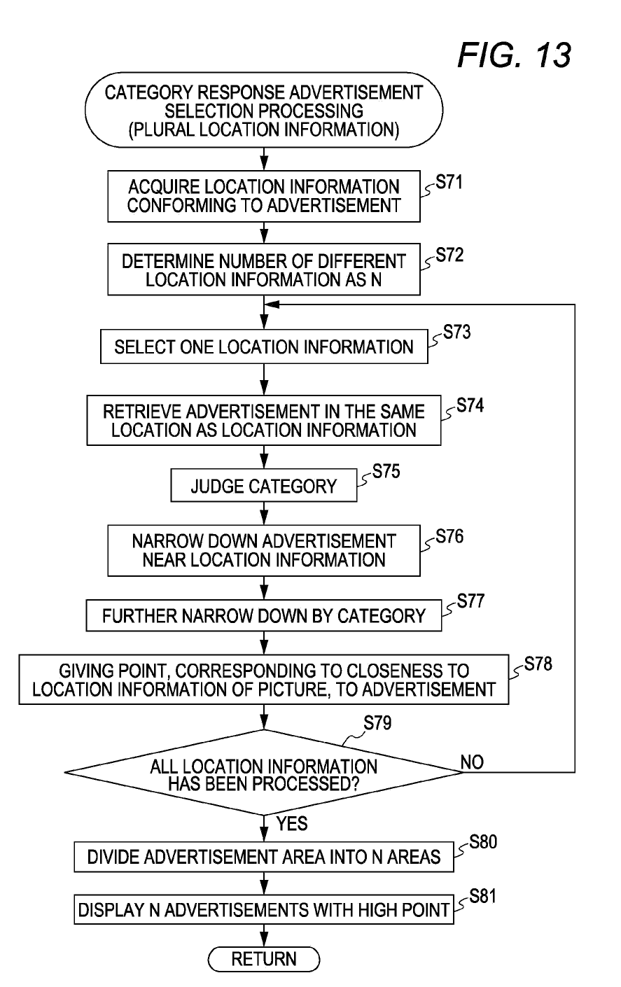

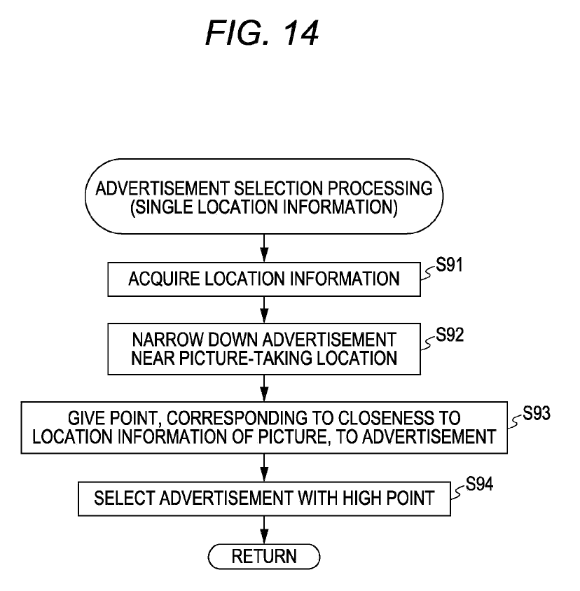

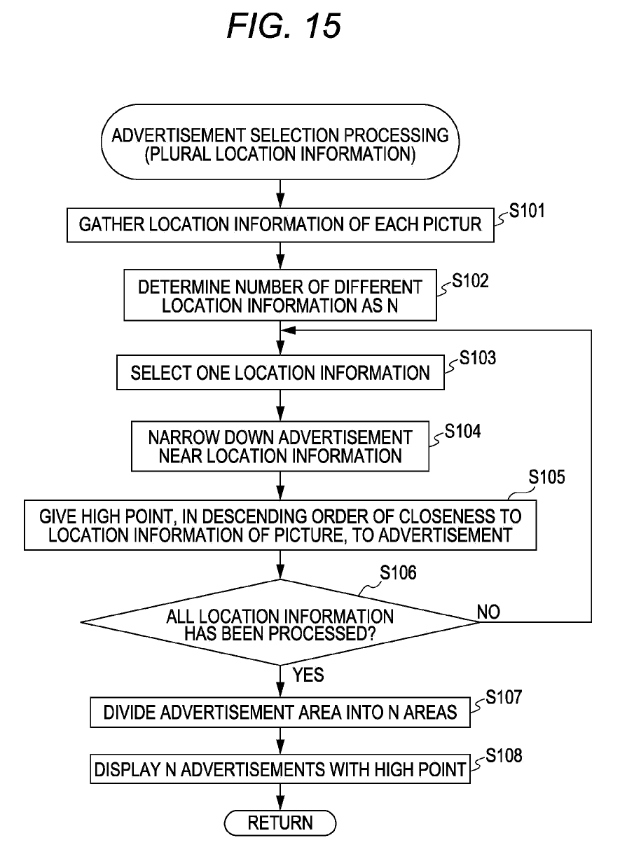

FIG. 9 is a flow chart showing a procedure of a web page distribution processing. Hereinafter, the process shown in FIG. 9 is described along the operation numbers. This processing is started when the access receiving part 140 has received the viewing request, showing the acquisition of the page data in the personal site information storage part 110, from the user device 31.

[Operation S11] The access receiving part 140 gives the received viewing request to the display target image judgment part 150. The display target image judgment part 150 then acquires the page data to be displayed from the personal site information storage part 110.

[Operation S12] The display target image judgment part 150 retrieves the description showing the picture data to be inline displayed from the acquired page data. The display target image judgment part 150 then acquires the picture data to be inline displayed from the personal site information storage part 110 to give the acquired picture data to the display target advertisement determination part 160. There may be only one or a plurality of picture data to be inline displayed.

[Operation S13] The display target image judgment part 150 determines whether or not a comment is attached to the description associated with the picture data which is included in the page data and should be inline displayed. When the comment is attached to the description, the comment is passed to the display target advertisement determination part 160, and the process proceeds to operation S14. When there is no comment, the process proceeds to operation S17.

[Operation S14] The display target advertisement determination part 160 extracts the location information from the picture data which should be inline displayed. At this time, when there is a plurality of picture data which should be inline displayed, a plurality of location information is extracted. When a plurality of location information representing the same location is extracted, the display target advertisement determination part 160 destroys the location information with one location information (excludes the overlapping). The display target advertisement determination part 160 then determines whether the remaining location information is one or plural. When there is single location information, the process proceeds to operation S15. When there is a plurality of remaining location information, the process proceeds to operation S16.

[Operation S15] The display target advertisement determination part 160 performs a comment response advertisement selection processing based on single location information. The detail of this processing will be described later (see, FIG. 10). Thereafter, the process proceeds to operation S24.

[Operation S16] The display target advertisement determination part 160 performs a comment response advertisement selection processing based on a plurality of location information. The detail of this processing will be described later (see, FIG. 11). Thereafter, the process proceeds to operation S24.

[Operation S17] The display target advertisement determination part 160 extracts the location information from the picture data which should be inline displayed. At this time, when there is a plurality of picture data which should be inline displayed, a plurality of location information is extracted, and the overlapping is excluded. The display target advertisement determination part 160 then refers to the advertisement management table 122 and retrieves the advertisement having the location information conforming to the location information of the picture data. At this time, if the location information is within a predetermined error range from the location information of the picture data, the location information of the advertisement is determined to conform to the location information of the picture data. When there is an advertisement with the location information conforming to the location information of the picture data, the process proceeds to operation S18. When there is no such an advertisement, the process proceeds to operation S21.

[Operation S18] The display target advertisement determination part 160 determines whether or not the location information conforming to the advertisement is only one. When there is only one location information conforming to the advertisement, the process proceeds to operation S19. When there is a plurality of location information conforming to the advertisement, the process proceeds to operation S20.

[Operation S19] The display target advertisement determination part 160 performs a category response advertisement selection processing based on single location information. The detail of this processing will be described later (see, FIG. 12). Thereafter, the process proceeds to operation S24.

[Operation S20] The display target advertisement determination part 160 performs the category response advertisement selection processing based on a plurality of location information. The detail of this processing will be described later (see, FIG. 13). Thereafter, the process proceeds to operation S24.

[Operation S21] The display target advertisement determination part 160 extracts the location information from the picture data which should be inline displayed. At this time, when there is a plurality of picture data which should be inline displayed, a plurality of location information is extracted, and the overlapping is excluded. The display target advertisement determination part 160 then determines whether the location information is one or plural. When there is single location information, the process proceeds to operation S22. When there is a plurality of location information, the process proceeds to operation S23.

[Operation S22] The display target advertisement determination part 160 performs an advertisement selection processing based on single location information. The detail of this processing will be described later (see, FIG. 14). Thereafter, the process proceeds to operation S24.

[Operation S23] The display target advertisement determination part 160 performs the advertisement selection processing based on a plurality of location information. The detail of this processing will be described later (see, FIG. 15).

[Operation S24] The advertisement attachment part 170 gives the description for inline displaying the selected advertisement to the page data acquired in operation S11. The page transmission part 180 then transmits the page data to the user device 31.

Next, each advertisement selection processing is described in detail. First, the advertisement selection processing in which only one location information is extracted from the picture data, and a comment is attached to the picture data.

FIG. 10 is a flow chart showing a procedure of a comment response advertisement selection processing based on single location information. Hereinafter, the process shown in FIG. 10 is described along the operation numbers.

[Operation S31] The display target advertisement determination part 160 acquires single location information extracted from the picture data.

[Operation S32] The display target advertisement determination part 160 narrows down the advertisement near a picture-taking location into an adjacent advertisement number X (X is a natural number of not less than 1). Specifically, the display target advertisement determination part 160 refers to the advertisement management table 122 and calculates a distance between the picture-taking location and the location of an advertisement target from latitude and longitude shown in the location information of each advertisement and latitude and longitude shown in the location information of the picture data.

The square of a displacement of a distance in south and north directions corresponding to the difference in latitude is added to the square of a displacement of a distance in east and west directions corresponding to the difference in longitude, and a square root of the result of the addition is calculated, whereby the distance based on the latitude and longitude can be calculated. The difference in latitude is represented by a radian unit to be multiplied to the radius of the earth, whereby the displacement of the distance in the south and north directions corresponding to the difference in latitude can be calculated.

When the displacement of the distance in the east and west directions corresponding to the difference in longitude is calculated, the cosine of a value in the unit of radian of the longitude (the longitude of the picture data) is first multiplied with the radius of the earth. According to this calculation, the distance from the axis of the earth to the appropriate location can be obtained. In addition, the difference in longitude is represented by the radian unit to be multiplied with the distance from the axis of the earth, whereby the displacement of the distance in the east and west directions can be obtained.

The display target advertisement determination part 160 selects the advertisements of the adjacent advertisement number X sequentially from the advertisements having the location information near the location information of the picture data.

[Operation S33] The display target advertisement determination part 160 acquires the character string of the comment, shown in an inline display position of the picture data, from the page data.

[Operation S34] The display target advertisement determination part 160 further narrows down the advertisements by the acquired character string. Specifically, the display target advertisement determination part 160 extracts the character string representing the category of the advertisement from the acquired character strings. For example, when the character string “taken at the AA restaurant” can be obtained, the character string representing the category “restaurant” is extracted there from. Next, the display target advertisement determination part 160 retrieves the advertisement of the category, falling into the extracted character string, from the advertisement selected in the operation S32. The category to which each advertisement belongs can be determined by referring to the advertisement management table 122.

[Operation S35] The display target advertisement determination part 160 determines whether or not the appropriate advertisement is hit in operation S34. When the appropriate advertisement has been found, the process proceeds to operation S37. When the appropriate advertisement has not been found, the process proceeds to operation S36.

[Operation S36] When the advertisement of the category represented by the character string extracted from the comment cannot be detected, the display target advertisement determination part 160 widens a selection range of the advertisement. Specifically, the display target advertisement determination part 160 increases the value of the adjacent advertisement number X. Thereafter, the process proceeds to operation S32, and the adjacent advertisement is narrowed down again.

[Operation S37] The display target advertisement determination part 160 gives a point, corresponding to closeness to the location information of the picture data, to the advertisement hit in operation S35. Namely, as the distance between the location information of the picture data and the location information of the advertisement is shorter, a higher point is given to the advertisement.

[Operation S38] The display target advertisement determination part 160 selects a predetermined number of advertisements with a high point to determine the advertisements as the display target advertisements.

According to the above embodiment, the advertisement corresponding to a comment can be selected based on single location information.

Next, the advertisement election processing in which a plurality of location information is extracted from the picture data, and a comment is attached to the picture data.

FIG. 11 is a flow chart showing a procedure of the comment response advertisement selection processing based on a plurality of location information.

[Operation S41] The display target advertisement determination part 160 acquires a plurality of location information extracted from the picture data.

[Operation S42] The display target advertisement determination part 160 determines the number of different location information as N (N is a natural number of not less than 1).

[Operation S43] The display target advertisement determination part 160 selects one location information from unselected location information.

[Operation S44] The display target advertisement determination part 160 narrows down the advertisement near a location shown by the selected location information into the adjacent advertisement number X (X is a natural number of not less than 1). Specifically, the display target advertisement determination part 160 refers the advertisement management table 122 and calculates a distance between the location shown by the selected location information and the location of the advertisement target from latitude and longitude represented by the location information of each advertisement and latitude and longitude represented by the selected location information. The display target advertisement determination part 160 selects the advertisements of the adjacent advertisement number X sequentially from the advertisements having the location information near the selected location information.

[Operation S45] The display target advertisement determination part 160 acquires from the page data the character string of the comment, shown in the inline display position of the picture data which is an extraction source of the location information.

[Operation S46] The display target advertisement determination part 160 further narrows down the advertisements by the acquired character string. Specifically, the display target advertisement determination part 160 extracts the character string representing the category of the advertisement from the acquired character strings. Next, the display target advertisement determination part 160 retrieves the advertisement of the category, falling into the extracted character string, from the advertisements selected in the operation S44.

[Operation S47] The display target advertisement determination part 160 determines whether or not the appropriate advertisement is hit in operation S46. When the appropriate advertisement has been found, the process proceeds to operation S49. When the appropriate advertisement has not been found, the process proceeds to operation S48.

[Operation S48] When the advertisement of the category represented by the character string extracted from the comment cannot be detected, the display target advertisement determination part 160 widens the selection range of the advertisement. Specifically, the display target advertisement determination part 160 increases the value of the adjacent advertisement number X. Thereafter, the process proceeds to operation S44, and the adjacent advertisement is narrowed down again.

[Operation S49] The display target advertisement determination part 160 gives a point, corresponding to closeness to the location information selected in operation S43, to the advertisement hit in operation S35.

[Operation S50] The display target advertisement determination part 160 determines whether or not all location information is selected in operation S43. When there is unselected location information, the process proceeds to operation S43. When all the location information is selected, the process proceeds to operation S51.

[Operation S51] The display target advertisement determination part 160 divides the advertisement area attached to display target page data into N areas.

[Operation S52] The display target advertisement determination part 160 selects N advertisement with a high point as the display target advertisement.

Next, the advertisement selection processing in a case where only one location information is extracted from the picture data and there is an advertisement having the location information coinciding with the extracted location information is described.

FIG. 12 is a flow chart showing a procedure of the category response advertisement selection processing based on single location information. Procedures shown in FIG. 12 will be described along the Operation numbers hereafter.

[Operation S61] The display target advertisement determination part 160 acquires single location information which is extracted from the picture data and conforms to the location information of the advertisement.

[Operation S62] The display target advertisement determination part 160 discriminates the advertisement in the same location as the location of the acquired location information. Specifically, the display target advertisement determination part 160 discriminates the advertisement, on which the location information conforming to the acquired location information within a prescribed error range is registered, from the advertisement management table 122.

[Operation S63] The display target advertisement determination part 160 refers to the advertisement management table 122 and judges the category of the advertisement discriminated in operation S62.

[Operation S64] The display target advertisement determination part 160 narrows down the advertisement near a location shown by the selected location information into the adjacent advertisement number X (X is a natural number of not less than 1). Specifically, the display target advertisement determination part 160 refers the advertisement management table 122 and calculates a distance between the location shown by the acquired location information and the location of the advertisement target from the latitude and longitude represented by the location information of each advertisement and latitude and longitude acquired in operation S61. The display target advertisement determination part 160 then selects the advertisements of the adjacent advertisement number X sequentially from the advertisements having the location information near the acquired location information.

[Operation S65] The display target advertisement determination part 160 further narrows down the advertisement by the category judged in operation S63. Specifically, the display target advertisement determination part 160 retrieves the advertisement of the category, judged in operation S63, from the advertisement selected in operation S64.

[Operation S66] The display target advertisement determination part 160 gives a point, corresponding to closeness to the location information of the picture data, to the advertisement hit in operation S65. Namely, as the distance between the location information of the picture data and the location information of the advertisement is shorter, a higher point is given to the advertisement.

[Operation S67] The display target advertisement determination part 160 selects a predetermined number of advertisements with a high point to determine the advertisements as the display target advertisements.

Next, the advertisement selection processing in a case where a plurality of location information is extracted from the picture data, and the extracted location information includes a plurality of location information conforming to the location information of the advertisement.

FIG. 13 is a flow chart showing a procedure of the category response advertisement selection processing based on a plurality of location information. Hereinafter, the process shown in FIG. 13 is described along the operation numbers.

[Operation S71] The display target advertisement determination part 160 acquires a plurality of location information which is extracted from the picture data and conform to the location information of the advertisement.

[Operation S72] The display target advertisement determination part 160 determines the number of different location information as N.

[Operation S73] The display target advertisement determination part 160 selects one location information from unselected location information.

[Operation S74] The display target advertisement determination part 160 discriminates the advertisement in the same location as the location of the acquired location information. Specifically, the display target advertisement determination part 160 discriminates the advertisement, on which the location information conforming to the selected location information within a prescribed error range is registered, from the advertisement management table 122.

[Operation S75] The display target advertisement determination part 160 refers to the advertisement management table 122 and judges the category of the advertisement discriminated in operation S74.

[Operation S76] The display target advertisement determination part 160 narrows down the advertisement near a location shown by the selected location information into the adjacent advertisement number X (X is a natural number of not less than 1). Specifically, the display target advertisement determination part 160 refers the advertisement management table 122 and calculates the distance between the location shown by the acquired location information and the location of the advertisement target from the latitude and longitude represented by the location information of each advertisement and the latitude and longitude acquired in operation S61. The display target advertisement determination part 160 then selects the advertisements of the adjacent advertisement number X sequentially from the advertisements having the location information near the acquired location information.

[Operation S77] The display target advertisement determination part 160 further narrows down the advertisement by the category judged in operation S75. Specifically, the display target advertisement determination part 160 retrieves the advertisement of the category, judged in operation S75, from the advertisement selected in operation S74.

[Operation S78] The display target advertisement determination part 160 gives a point, corresponding to closeness to the location information of the picture data, to the advertisement hit in operation S65. Namely, as the distance between the location information of the picture data and the location information of the advertisement is shorter, a higher point is given to the advertisement.

[Operation S79] The display target advertisement determination part 160 determines whether or not all location information is selected in operation S73. When there is unselected location information, the process proceeds to operation S73. When all the location information is selected, the process proceeds to operation S80.

[Operation S80] The display target advertisement determination part 160 divides the advertisement area attached to display target page data into N areas.

[Operation S81] The display target advertisement determination part 160 selects N advertisements with a high point as the display target advertisement.

Next, the advertisement selection processing in a case where only one location information is extracted from the picture data and the advertisement having the location information near the extracted location information is selected is described.

FIG. 14 is a flow chart showing a procedure of the advertisement selection processing based on single location information. Hereinafter, the process shown in FIG. 14 is described along the operation numbers.

[Operation S91] The display target advertisement determination part 160 acquires single location information extracted from the picture data.

[Operation S92] The display target advertisement determination part 160 narrows down the advertisement near the location shown by the selected location information into the adjacent advertisement number X (X is a natural number of not less than 1). Specifically, the display target advertisement determination part 160 refers to the advertisement management table 122 and calculates the distance between the location shown by the acquired location information and the location of the advertisement target from the latitude and longitude represented by the location information of each advertisement and the latitude and longitude shown by the location information acquired in operation S91. The display target advertisement determination part 160 then selects the advertisements of the adjacent advertisement number X sequentially from the advertisements having the location information near the acquired location information.

[Operation S93] The display target advertisement determination part 160 gives a point, corresponding to closeness to the location information of the picture data, to the advertisement selected in operation S92. Namely, as the distance between the location information of the picture data and the location information of the advertisement is shorter, a higher point is given to the advertisement.

[Operation S94] The display target advertisement determination part 160 selects a predetermined number of advertisements with a high point to determine the advertisements as the display target advertisements.

Next, the advertisement selection processing will be explained in a case where a plurality of location information is extracted from the picture data, and the advertisement having the location information near each location information is selected.

FIG. 15 is a flow chart showing a procedure of the advertisement selection processing based on a plurality of location information. Hereinafter, the process shown in FIG. 15 is described along the operation numbers.

[Operation S101] The display target advertisement determination part 160 acquires a plurality of location information extracted from the picture data.

[Operation S102] The display target advertisement determination part 160 determines the number of different location information as N.

[Operation S103] The display target advertisement determination part 160 selects one location information from unselected location information.

[Operation S104] The display target advertisement determination part 160 narrows down the advertisement near the location shown by the selected location information into the adjacent advertisement number X (X is a natural number of not less than 1). Specifically, the display target advertisement determination part 160 refers to the advertisement management table 122 and calculates the distance between the location shown by the acquired location information and the location of the advertisement target from the latitude and longitude represented by the location information of each advertisement and the latitude and longitude acquired in operation S61. The display target advertisement determination part 160 then selects the advertisements of the adjacent advertisement number X sequentially from the advertisements having the location information near the acquired location information.

[Operation S105] The display target advertisement determination part 160 gives a point, corresponding to closeness to the location information of the picture data, to the advertisement selected in operation S104. Namely, as the distance between the location information of the picture data and the location information of the advertisement is shorter, a higher point is given to the advertisement.

[Operation S106] The display target advertisement determination part 160 determines whether or not all location information is selected in operation S103. When there is unselected location information, the process proceeds to operation S103. When all the location information is selected, the process proceeds to operation S107.

[Operation S107] The display target advertisement determination part 1 60 divides the advertisement area attached to display target page data into N areas.

[Operation S108] The display target advertisement determination part 160 selects N advertisements with a high point as the display target advertisement.

As described above, on the basis of the location information showing a picture-taking location displayed in a web page, the advertisement associated with a facility near the picture-taking location can be displayed in the web page. Hereinafter, in a case where it is assumed that the informant 20 posts a picture, taken at a facility in a city, on his website, an example of the advertisement displayed simultaneously with the picture is described.

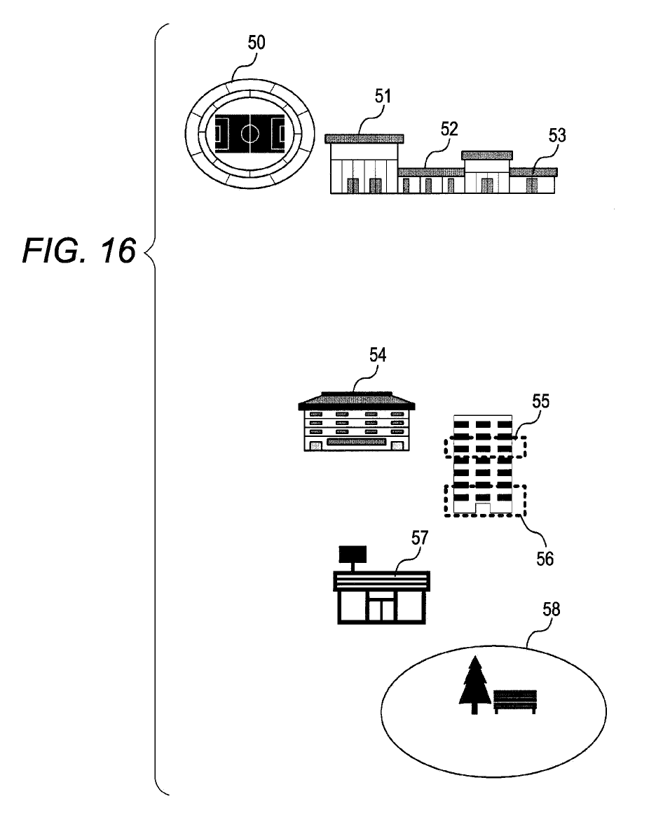

FIG. 16 is a view showing city's facilities. There is an AA stadium 50 at the north end of the city. A shopping mall is provided adjacent to the AA stadium 50. In the shopping mall, a CC electrical appliance shop 51, a KK restaurant 52, an RR restaurant 53, and other shops are in business. Further, there is a QQ museum 54 at the center of the city. There is a commercial building near the QQ museum 54. In the commercial building, an FF pub 55, a DD restaurant 56, and other shops are in business. In the south side of the city, an EE pub 57 is in business. There is a ZZ park 58 adjacent to the EE pub 57. Here, the CC electrical appliance shop 51, the KK restaurant 52, and the RR restaurant 53, the QQ museum 54, the FF pub 55, the DD restaurant 56, and the EE pub 57 are advertisers providing the advertisement from the web server 100.

It is assumed that the informant 20 takes a picture by the portable phone 21 in the above city, and the informant 20 posts the picture on his website. At this time, when the posted picture has been taken at a location other than the facilities of the advertisers, the advertisement of the facility near the picture-taking location is displayed based on only the location information.

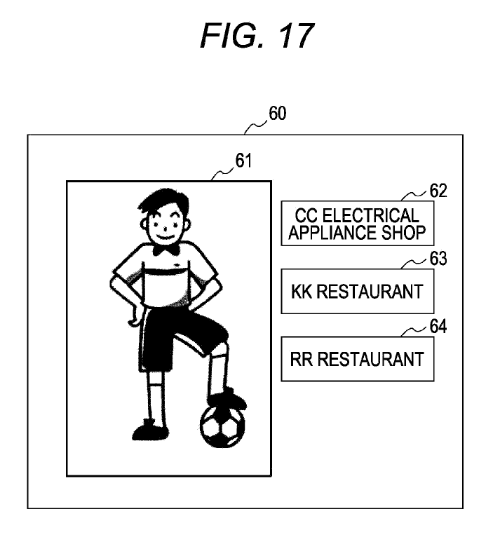

FIG. 17 is a view showing an example of advertisement display corresponding to a picture taken at one facility other than the facilities of the advertisers. One picture 61 taken at the AA stadium 50 is posted on a web page 60. A comment is not attached to the picture 61. At this time, since the AA stadium 50 is not the facility of the advertiser, there is no advertisement having the same location information as the location information attached to the picture 61.

In that case, the advertisement is selected by the advertisement selection processing based on single location information shown in FIG. 14. As a result, the advertisement of the facility near the AA stadium 50 is preferentially displayed. In the example of FIG. 17, advertisements 62 to 64 are displayed in the order of the CC electrical appliance shop 51, the KK restaurant 52, and the RR restaurant 53.

When a plurality of pictures taken at a location other than the facilities of the advertisers is posted on a web page, the advertisement of the facility near each of the picture-taking location is displayed.

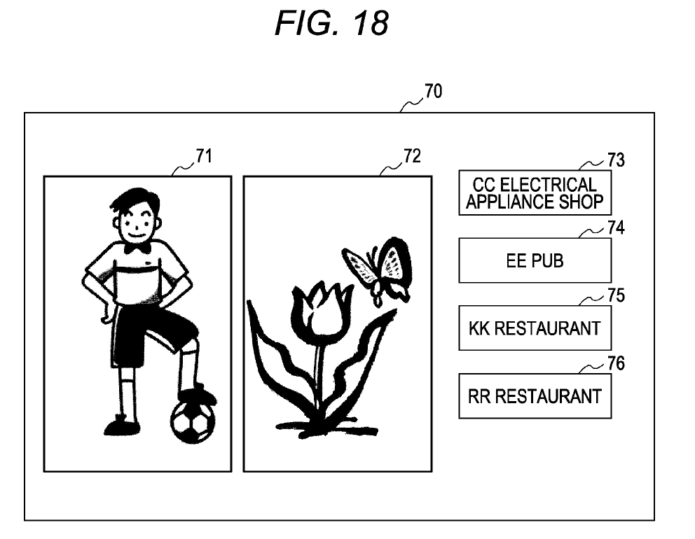

FIG. 18 is a view showing an example of advertisement display corresponding to a picture taken at a plurality of facilities other than the facilities of the advertisers. A picture 71 taken at the AA stadium 50 and a picture 72 taken at the ZZ park 58 are posted on a web page 70. A comment is not attached to the pictures 71 and 72. At this time, since the AA stadium 50 and the ZZ park 58 are not the facilities of the advertiser, there is no advertisement having the same location information as the location information attached to the pictures 71 and 72.

In that case, the advertisement is selected by the advertisement selection processing based on a plurality of location information shown in FIG. 15. As a result, the advertisements of the facilities, respectively provided near the AA stadium 50 and the ZZ park 58, are preferentially displayed. In the example of FIG. 18, advertisements 73 to 76 are displayed in the order of the CC electrical appliance shop 51, the EE pub 57, the KK restaurant 52, and the RR restaurant 53.

Next, a case where a picture taken at the facility of the advertiser is posted on the web page is described. The location information showing the location of the facility of the advertiser is attached to the picture taken at the facility of the advertiser. As a result, the location information of the picture and the location information of the advertisement conform to each other, and the advertisement belonging to the same category as the conforming advertisement is displayed together with the conforming advertisement.

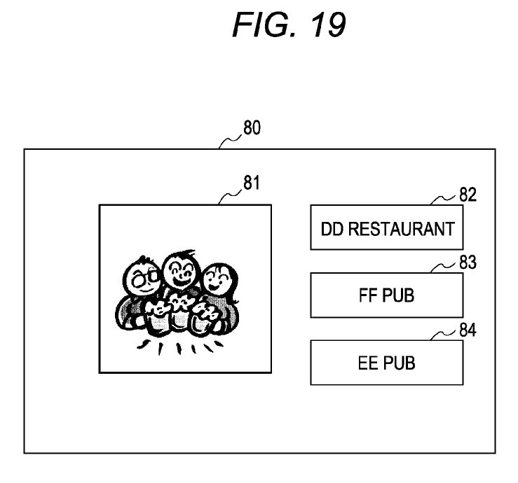

FIG. 19 is a view showing an example of advertisement display corresponding to a picture taken at one facility of the advertiser. One picture 81 taken at the DD restaurant 56 is posted on a web page 80. A comment is not attached to the picture 81. At this time, since the DD restaurant 56 is the facility of the advertiser, there is the advertisement having the same location information as the location information attached to the picture 81.

In the above case, the advertisement is selected by the category response advertisement selection processing based on single location information shown in FIG. 12 is selected. As a result, regarding the advertisements belonging to the same category as the advertisement conforming in the location information, the advertisement having the location information near the picture-taking location is preferentially displayed.

As shown in FIG. 16, the FF pub 55 is included in the same building as the DD restaurant 56. The FF pub 55 is also the facility of the advertiser. Thus, in addition to the advertisement of the DD restaurant 56, the advertisement of the FF pub 55 has the same location information as the location information of the picture 81 taken at the DD restaurant 56. Therefore, as the category of the advertisement having the same location information as the location information of the picture 81 taken at the DD restaurant 56, “restaurant” and “pub” is selected. As a result, the advertisements 82 to 84 of the DD restaurant 56, the FF pub 55, and the EE pub 57 are displayed on the web page 80.

When pictures taken at a plurality of facilities of the advertiser are posted on the web page, the advertisement belonging to the same category as the advertisement conforming to the location information of each of the pictures is displayed.

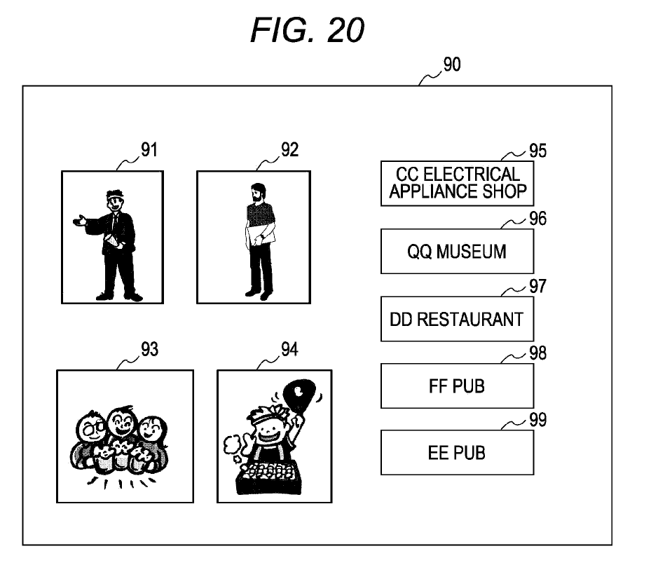

FIG. 20 is a view showing an example of advertisement display corresponding to a picture taken at a plurality of facilities of the advertiser. A picture 91 taken at the CC electrical appliance shop 51, a picture 92 taken at the QQ museum 54, a picture 93 taken at the DD restaurant 56, and a picture taken at the EE pub 57 are posted on a web page 90. A comment is not attached to each of the pictures 91 to 94. At this time, since the facilities at which each picture has been taken are owned by the advertisers, there is the advertisement having the same location information as the location information attached to the picture 81.

In that case, the advertisement is selected by the category response advertisement selection processing based on a plurality of location information shown in FIG. 13. As a result, regarding the advertisements belonging to the same category as the advertisement conforming in the location information, advertisements 95 to 99 having the location information near the picture-taking location are preferentially displayed.

When a comment is attached to the picture, the advertisements are narrowed down based on the category shown by the comment.

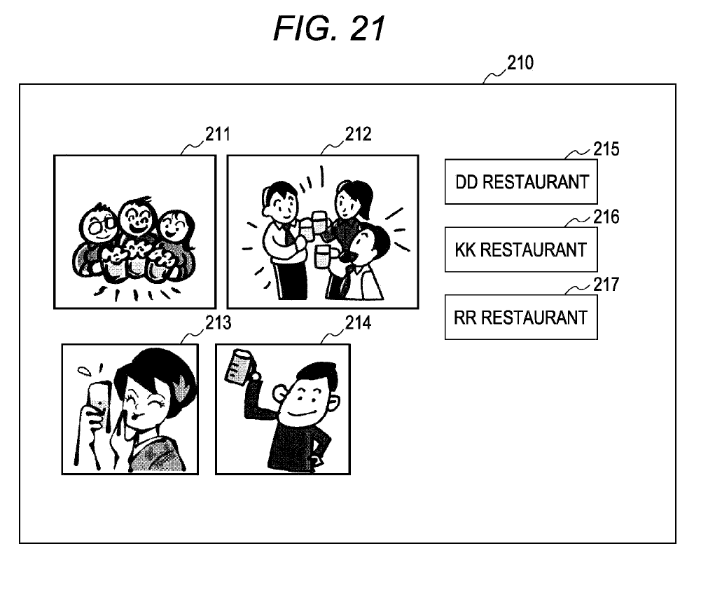

FIG. 21 is a view showing an example of advertisement display corresponding to a picture taken at one facility. A plurality of pictures 211 to 214 taken at the DD restaurant 56 is posted on a web page 210. Since each of the pictures 211 to 214 have been taken at the same place, they have the same location information. Thus, only one location information is used in the selection of the advertisement.

The comment “toasting at a restaurant” is attached to the pictures 211 to 214. The character string representing the category “restaurant” can be extracted from the comment. In this case, the advertisement is selected by the comment response advertisement selection processing based on single location information shown in FIG. 10. As a result, regarding the advertisements of restaurants, advertisements 215 to 217 are preferentially displayed in the order closer to the DD restaurant 56. Compared to FIG. 19, the advertisement of the FF pub 55 is not displayed on the web page 210 of FIG. 21. This is because the narrowing by the category “restaurant” based on the comment becomes possible.

A comment may be attached to each picture taken at a plurality of locations. In this case, the category is narrowed down based on the category shown in each comment.

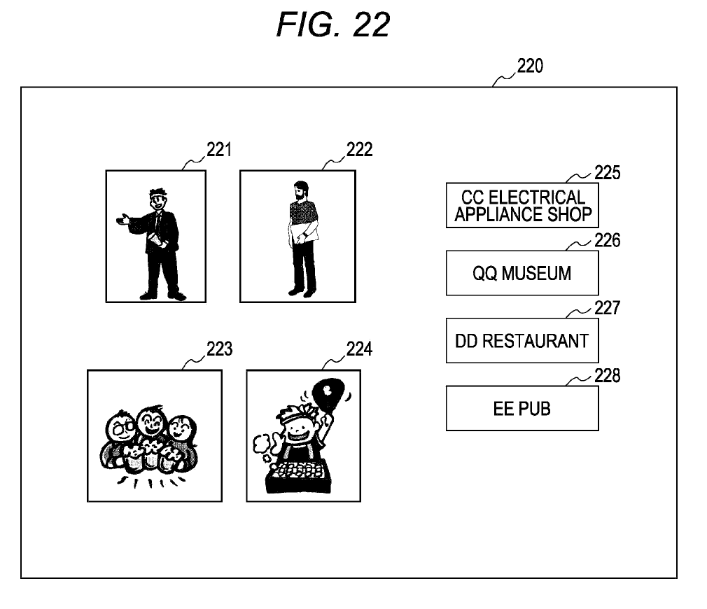

FIG. 22 is a view showing an example of advertisement display corresponding to the comment of a picture taken at a plurality of facilities. A picture 221 taken at the CC electrical appliance shop 51, a picture 222 taken at the QQ museum 54, a plurality of pictures 223 taken at the DD restaurant 56, and a picture 224 taken at the EE pub 57 are posted on a web page 220. Since the pictures 221 to 224 have been taken at a different location, they have individual location information. Thus, the advertisement is selected based on a plurality of location information.

In this case, the advertisement is selected by the comment response advertisement selection processing based on a plurality of location information shown in FIG. 11. As a result, the respective advertisements 225 to 228 of the CC electrical appliance shop 51, the QQ museum 54, the DD restaurant 56, and the EE pub 57 are displayed.

Thus, when a web page is distributed, in addition to a picture inline displayed on the web page, an advertisement image associated with a facility of an advertiser near a location where the picture has been taken can be distributed. As a result, when a person who has viewed the web page is interested in the location where the picture posted on the web page has been taken, the person can display the detail contents of the related location by selecting the advertisement displayed simultaneously with the picture.

The above processing function can be realized by a computer. In this case, a program in which the process contents of a function that the web server 100 should have are described is provided. The program is executed by the computer, whereby the above processing function can be realized on the computer. The program in which the process contents are described can be recorded in a computer readable recording medium. As the computer readable recording medium, there are a magnetic recording device, an optical disk, an optical magnetic recording medium, a semiconductor memory, and the like. As the magnetic recording device, there are a hard disk device (HDD), a flexible disk (FD), a magnetic tape, and the like. As the optical disk, there are a DVD (Digital Versatile Disc), a DVD-RAM, a CD-ROM (Compact Disc Read Only Memory), a CD-R (Recordable)/RW (ReWritable), and the like. As the optical magnetic recording medium, there is an MO (Magneto-Optical disc) and the like.

When a program is distributed, for example, portable recording media such as a DVD and a CD-ROM in which the program is recorded are sold. Meanwhile, the program is stored in a storage device in a server computer, and the program can be transferred from the server computer to other computer through the network.

The computer executing a program stores in its storage device, for example, a program recorded in a portable recording medium or a program transferred from a server computer. The computer then reads out the program from its storage device and executes a process in accordance with the program. The computer can also read out the program directly from the portable recording medium to execute the process in accordance with the program. Further, the computer can also sequentially execute the process in accordance with the received program for each transfer of the program from the server computer.

According to the invention, the advertisement image of the advertisement target facility near the location where the picture data as the display target image has been taken is preferentially displayed in the content.

It is to be noted that the invention is not limited only to the above-described embodiment and can be variously modified without departing from the scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A content distribution server for distributing content through a network, comprising:
a content storage storing an electronic document showing the contents of the content and including a description for designating picture data to be displayed in the content and the picture data attached with location information showing a picture-taking location;
an advertisement information storage storing a plurality of advertisement images corresponding to location information showing a location of an advertisement target facility;
a viewing request receiver receiving a request for viewing the content from a user device connected through the network;
a display target image judge acquiring the electronic document, showing the contents of the content designated by the viewing request, from the content storage and judges the picture data, designated as the display target by the acquired electronic document, as a display target image;
a display target advertisement determiner acquiring the location information attached to the display target image, calculates a distance between a location where the display target image has been taken and each of a plurality of advertisement target facilities from the acquired location information and each location information of a plurality of advertisement images in the content storage, and preferentially determines an advertisement image of the advertisement target facility, located at a close distance from the location where the display target image has been taken, as the display target;
an advertisement attacher adding an advertisement display description, for displaying the advertisement image determined as the display target by the display target advertisement determiner, to the electronic document showing the contents of the content designated by the viewing request; and
an electronic document sender sending the electronic document, to which the advertisement display description is added by the advertisement attacher, to the user device.

2. The content distribution server according to claim 1, wherein a category of the advertisement target facility corresponding to the advertisement image is registered on the advertisement information storage, and the display target advertisement determiner detects an advertisement image corresponding to the location information showing the same location as the location information of the display target image, refers to the advertisement information storage, determines the category of the detected advertisement image, and, regarding the advertisement images in the same category as the detected advertisement image, preferentially determines the advertisement images of the advertisement target facility, located at a close distance from the picture-taking location, as the display target.

3. The content distribution server according to claim 1, wherein a category of the advertisement target facility corresponding to the advertisement image is registered on the advertisement information storage, when a comment for the display target image is attached to the content designated by the viewing request, the display target image judge extracts the attached comment, the display target advertisement determiner retrieves a character string, representing the category, from the comment extracted by the display target image judge and, regarding the advertisement images in the same category as the category represented by the detected character string, preferentially determines the advertisement image of the advertisement target facility, located at a close distance from the picture-taking location, as the display target.

4. The content distribution server according to claim 3, wherein the display target image judge determines the character string, described before and after a tag showing a display position of the display target image in the content designated by the viewing request, as the comment of the display target image.

5. The content distribution server according to claim 1, wherein
a category of the advertisement target facility corresponding to the advertisement image is registered on the advertisement information storage,
when a comment is attached to the display target image in the content designated by the viewing request, the display target image judge extracts the attached comment, and
the display target advertisement determiner retrieves a character string showing the category from the comment extracted by the display target image judge, when the character string can be detected, regarding the advertisement images in the same category as the category represented by the detected character string, preferentially determines the advertisement image of the advertisement target facility, located at a close distance from the picture-taking location, as the display target, when the comment is not attached to the display target image and when the character string representing the category cannot be detected from the attached comment, detects the advertisement image corresponding to the location information showing the same location as the location information of the display target image, refers to the advertisement information storage to determine the category of the detected advertisement image, and, regarding the advertisement images in the same category as the detected advertisement image, preferentially determines the advertisement image of the advertisement target facility, located at a close distance from the picture-taking location, as the display target.

6. The content distribution server according to claim 5, wherein when the comment is not attached to the display target image, when the character string representing the category cannot be detected from the attached comment, and when the advertisement image corresponding to the location information showing the same location as the location information of the display target image cannot be detected, the display target advertisement determiner preferentially determines the advertisement image of the advertisement target facility, located at a close distance from the picture-taking location, as the display target from among all the advertisement images.

7. The content distribution server according to claim 1, wherein when there is a plurality of display target images, the display target advertisement determiner preferentially determines the advertisement image, located at a close distance from any of the plurality of display target images, as the display target.

8. The content distribution server according to claim 1, wherein latitude and longitude of the picture-taking location as the location information are attached to the picture data stored in the content storage.

9. The content distribution server according to claim 1, wherein a plurality of advertisement image files in which the advertisement image is stored and an advertisement management table on which a correspondence relation between the location information of the advertisement and the advertisement image file is registered are stored in the advertisement information storage.

10. The content distribution server according to claim 9, wherein latitude and longitude of the advertisement target facility as the location information are registered on the advertisement management table.

11. A computer readable recording medium in which a content distribution program for distributing content on a computer through a network is recorded, in the recording medium, the content distribution program operating as:
a content storage storing an electronic document showing the contents of the content and including a description for designating picture data to be displayed in the content and the picture data attached with location information showing a picture-taking location;
an advertisement information storage storing a plurality of advertisement images corresponding to location information showing a location of an advertisement target facility;
a viewing request receiver receiving a request for viewing the content from a user device connected through the network;
a display target image judge acquiring the electronic document, showing the contents of the content designated by the viewing request, from the content storage and judges the picture data, designated as the display target by the acquired electronic document, as a display target image;
a display target advertisement determiner acquiring the location information attached to the display target image, calculates a distance between a location where the display target image has been taken and each of a plurality of advertisement target facilities from the acquired location information and each location information of a plurality of advertisement images in the content storage, and preferentially determines an advertisement image of the advertisement target facility, located at a close distance from the location where the display target image has been taken, as the display target;
an advertisement attacher adding an advertisement display description, for displaying the advertisement image determined as the display target by the display target advertisement determiner, to the electronic document showing the contents of the content designated by the viewing request; and
an electronic document sender which sends the electronic document, to which the advertisement display description is added by the advertisement attacher, to the user device.

12. A content distribution method for distributing content on a computer through a network, comprising:
by the computer,
receiving a viewing request of the content from a user device connected through the network;
acquiring an electronic document showing the contents of the contents and including a description for designating picture data to be displayed in the content and acquiring an electronic document showing the contents of the contents designated by the viewing request from a content storage storing the picture data attached with location information showing a picture-taking location;
judging the picture data, designated as a display target in the acquired electronic document, as a display target image;
acquiring the location information attached with the display target image and calculating a distance between a location where the display target image has been taken and each of a plurality of advertisement target facilities from the location information, showing a location of the advertisement target facility corresponding to each of the plurality of advertisement images and stored in an advertisement information storage, and the acquired location information;
preferentially determining the advertisement image of the advertisement target facility, located at a close distance from the location where the display target image has been taken, as the display target;
adding an advertisement display description for displaying the advertisement image determined as the display target to the electronic document showing the contents of the content designated by the viewing request; and
sending the electronic document, added with the advertisement display description, to the user device.
